(19) United States
(12) Patent Application Publication
(10) Pub. No.: US 2015/0094128 A1
(43) Pub. Date: Apr. 2, 2015

(54) Online Fantasy Racing League Game

(71) Applicant: Steve Montgomery, Torrance, CA (US)

(72) Inventor: Steve Montgomery, Torrance, CA (US)

(21) Appl. No.: 14/500,613

(22) Filed: Sep. 29, 2014

Related U.S. Application Data
(60) Provisional application No. 61/884,814, filed on Sep. 30, 2013.

(51) Int. Cl. A63F 13/828; A63F 13/537

(52) U.S. Cl. CPC A63F 13/828; A63F 13/537
USPC 463/6

(57) ABSTRACT

An online fantasy racing game in which users select a finishing order of an auto race, such as NASCAR, and compete against team members or other teams. A selection tool is provided to assist users in selecting a finishing order of the drivers. The selection tool utilizes a unique algorithm to calculate a preliminary finishing order. The user can utilize the selection tool to modify the preliminary finishing order to the user's own predicted finishing order. The user can modify the user's predicted finishing order manually. A viewing page allows all users to see who is winning the online fantasy game. The display may be color coded to quickly and easily determine how one is doing in the game.

### CROSS-REFERENCE TO RELATED APPLICATION

This patent application claims the benefit of U.S. Provisional Patent Application Ser. No. 61/884,814, filed Sep. 30, 2013, entitled “Online Fantasy NASCAR Racing League.” which application is incorporated in its entirety here by this reference.

### TECHNICAL FIELD

This invention relates to online fantasy racing league games that follow the current top tier racing series, such as NASCAR.

### BACKGROUND

Fantasy sports increase interest and viewer participation in sports. Many websites have been established for various different sports where users can become intimately interested in the statistics of a sport, and have a more active role when watching sports. One sport that continues to grow, and in which some fantasy leagues are developing, is auto racing, such as NASCAR. Unfortunately, existing games that merely include selecting driver finishing order and viewing the race stats require improvement. For the foregoing reasons there is a need for an improved online fantasy racing league.

### SUMMARY

The present invention is directed to players competing against each other by choosing the final finishing order of every car in, for example, a 43 car field, of an auto race. Variations could include choosing 42 cars and sitting one out, choosing 41 and sitting two out, etc. Players sign up for a free account and can either join an existing team (e.g., of up to 5 members) and/or start their own team (e.g. of up to 5 members). For each weekly race, players choose what they think will be the final finishing order of each of the 43 cars in an upcoming race.

Points are awarded for each of the 43 cars based on their actual final finish positions. More points may be awarded depending on how accurate a player's final position choices were relative to the actual finishing positions.

Each player's points are totaled and displayed so the members of a team can easily see who is leading. Players can compete with other team members on a weekly basis or compete against other online fantasy teams with their cumulative totals.

A leaderboard of all players may show cumulative weekly totals. Race results are posted at periodic times throughout a given race and can be viewed live (as they are posted) or delayed (at one's own pace) depending on whether or not a player is watching a live broadcast or one recorded earlier (e.g., by DVR).

In some embodiments, prizes may be awarded for leading or winning.

### BRIEF DESCRIPTION OF DRAWINGS

FIG. 1 shows an embodiment of a webpage for setting up a game.

FIG. 2 shows an embodiment of a selection page to establish a finishing order of the drivers.

FIG. 3 shows an embodiment of a process for manually altering the finishing order.

FIG. 4A shows an embodiment of a viewing page.

FIG. 4B shows a close-up of a left portion of the viewing page shown in FIG. 4A.

FIG. 4C shows a close-up of a right portion of the viewing page shown in FIG. 4A.

FIG. 5 shows a close-up of the upper left corner of the viewing page shown in FIG. 4A.

FIG. 6 shows a partial view of the viewing page to show the highlighting feature when one driver icon is actuated.

FIG. 7 shows a close up of a portion of the viewing page to show the color spectrum display.

FIG. 8 shows a portion of the viewing page with the drop down menu actuated for different races.

FIG. 9 is a diagram of an exemplary environment in which the present invention may be implemented.

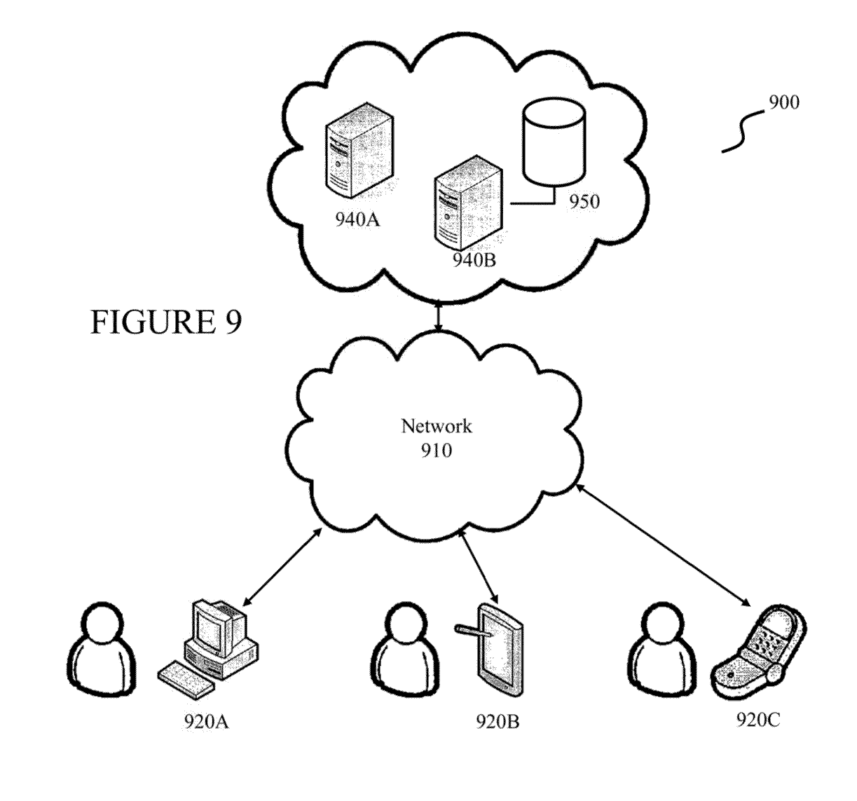

FIG. 10 is a high level diagram of a computer that may be used to implement various aspects of the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The invention of the present application is directed towards a system and method for playing a fantasy online sports game. In particular, the system is directed toward a racing sport such as stock car racing. The system allows users to pick and choose drivers in the order in which the user believes the drivers will finish a race. A selection tool is provided to assist users who may need assistance. A slider tool provides a mechanism to modify the order at any time prior to the beginning of the race. The system establishes a website for users to visit, register, and play the game.

### DEFINITIONS

The term “user” will generally refer to anyone who has registered to use the website for the fantasy sports game, and includes players.

The term “player” will generally refer to the specific user whose point of view is being described for the sake of clarity and ease of description.

The term “administrator” is a user with administrative authority who has established a team.

Registration

Every user will need to sign up and sign in to the system in order to choose their finishing order, view their results, and start/join a team. A website may be established for the users to sign in to the system. Users are granted the privilege of signing in once they have completed the standard process of choosing and submitting a unique user name, password, email address, and/or other typical identifying information.

In some embodiments, for security purposes, a link may be emailed, received, and followed for account verification. Actuating the email link will bring the user back to the website where he can sign in for the first time.

Setup

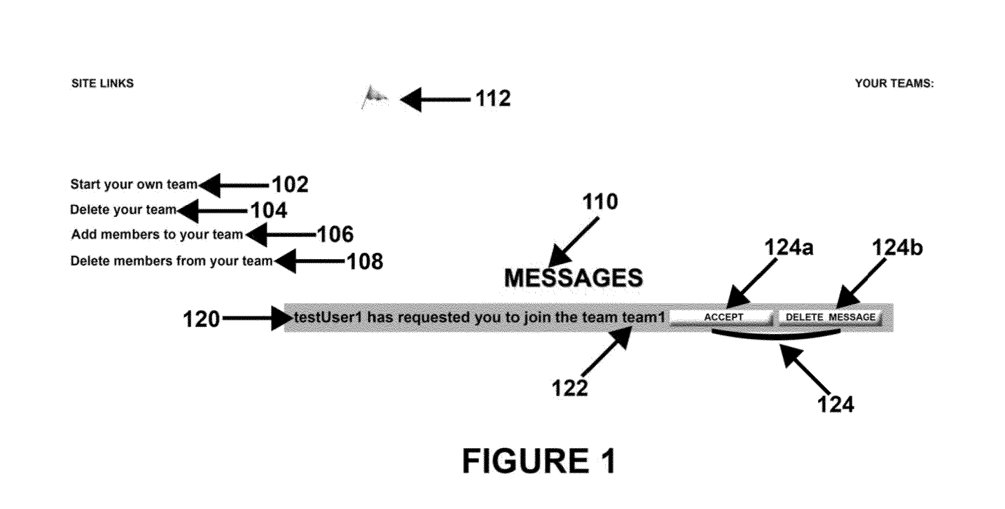

As shown in FIG. 1, a player can play as a part of a team, or play by himself. To play as a part of the team, the player can actuate a start your own team link and become the administrator of his own team. Alternatively, or in addition, the player can accept an invitation to join another user's team. In the preferred embodiment, a player may be limited to the number of administrator positions he holds as well as the number of teams he may be playing. By way of example only, the player may be allowed to be the administrator of one team and the member of no more than 4 other teams.

Starting a Team:

With reference to FIG. 1, in order to start one's own team, a start link 102 may be provided to allow the player to establish a unique team name and establish himself as an administrator. Once the team name is entered, the name may be verified to assure the name has not already been used. Invitation links 106 are then provided where the administrator can send invitation notices to those he wants to join the team. The invitation notices 110 may be via email or through the website. In addition, as the administrator, the player may delete his team 104, or delete members from his team 108.

Joining Another Team:

If a player is asked to join a team, he may receive an email notification 110 that provides a notice and/or a link to the website for the player to sign in and join the team. After signing in to the website, the player may see a message indicator 112 on his home page. The message indicator 112 may also appear on every webpage of the website. For example, the message indicator 112 may be a red flag at the top of the webpage alerting the player that a message is waiting for him.

As shown in FIG. 1, after clicking the message indicator 112 or upon signing, the player may see an invitation notice 110 containing the message indicating that another user would like the player to join the other user's team. The invitation notice may contain the user's name 120 who was requesting the invitation as well as his team name 122 so that the player knows whose team the player is being asked to join. The message box may further comprise a response section 124 that allows the player to respond to any messages left for him. In particular, the response section allows the player to either accept the invitation 124a or decline the invitation and delete the message 124b. The player can respond to each message one at a time and delete them as necessary.

If the player accepts the invitation, he will be added to the team stated in the message and the message may be deleted.

How to Play—Choosing Drivers:

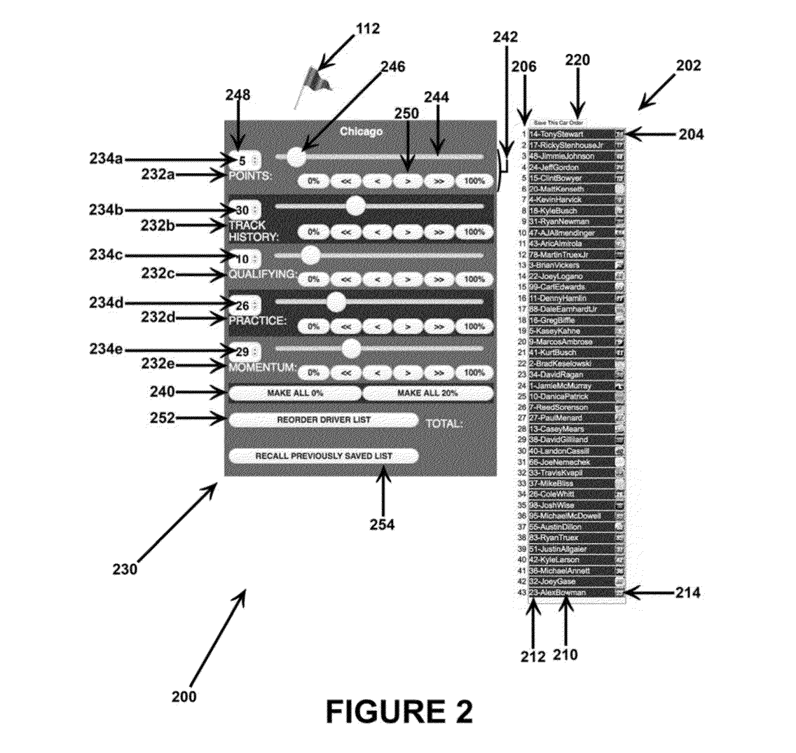

As shown in FIG. 2, whether a player plays as part of a team or by himself, he will be directed to a selection page 200 where he can choose a finishing order for an upcoming week's race. From any other page on the website, links may be provided as a tab, pull-down menu, text form, hyperlink, and the like, which leads the player to the selection page 200 where the finishing order can be established. The selection page 200 displays a drivers list 202 showing the current drivers in a particular race. If the player has not inputted any information, the finishing order may initially be displayed in an order predicted by the system (preliminary finishing order) as discussed below. The preliminary finishing order, or any finishing order, may display the driver's identification 204 and the driver's position 206. The driver's information 204 may include, for example, the driver's name 210, the driver's number 212, the driver's moniker 214, if any, and the like, and any combination thereof. The driver's moniker 214 may be any symbol, letter, number, marking, color, and the like, or any combination thereof that allows users to quickly and easily identify the driver without having to read the driver's name and number.

The listing 202 may be provided in table form in which each driver can be selected and moved to a different position on the list that corresponds with the driver's position 206. For example, being placed at the top of the list may indicate a first place position. Being placed at the bottom of the list may indicate a last place position. Moving any driver's position on the list automatically updates the position for all of the drivers if affected. A save button 220 may be provided that allows the player to save and submit his predicted order of drivers.

A selector tool 230 is provided as a starting point for choosing a finishing order. With reference to FIG. 2, the selector tool 230 comprises categories 232a-e that are scored and used in calculating points for each driver to mathematically determine a preliminary finishing order. The categories may comprise, but are not limited to, the current year's point standing (current ranking 232a), the track history for each driver's performance at the track for the upcoming race (track history 232b), the qualifying time for each driver for the upcoming race (qualifying time 232c), the average practice times for each driver for the upcoming race (practice time 232d), and the momentum for each driver coming into the upcoming race (momentum 232e). A score 234a-e is associated with each category. Other categories may be utilized that may have a bearing in predicting the driver's performance.

The current year's points standing 232a for a driver may be based on the current ranking of the driver, for example, the current NASCAR points standing of each driver that has qualified for the upcoming race. For example, in a race with 43 drivers, 43 points is given to the driver who is ranked highest, and 1 point is given to the driver who is ranked lowest to determine a current ranking score 234a for each driver. Therefore, the ranking and the points are inversely related (i.e. ranking of number 1 would have score of 43 in a race with 43 drivers).

For the track history 232b for each driver at the current week's track (i.e. the track for the upcoming race), each driver that has qualified for the race is ranked according to how well they have performed at the upcoming race's track since a given time. For example, the drivers may have driven on the upcoming race's track previously, and on multiple occasions over a designated period of time. The times for each driver may be averaged and ranked to determine a track history score 234b for each driver. For example, 43 points may be given to the driver who had the fastest average time and 1 point may be given to the driver with the slowest average time, with the rest falling somewhere in between. Alternatively, each driver's finishing position at the specified track may be averaged across the races he has had at that track within a specified period of time.

For the qualifying time 232c for each driver for the upcoming race, each driver is assigned points corresponding to the inverse of their rank for the qualifying time for the upcoming race. For example, 43 points may be given to the driver who had the fastest qualifying time and 1 point may be given to the driver with the slowest qualifying time, with the rest falling somewhere in between to determine a qualifying time score 234c for each driver.

For the average practice times 232d for each driver for the upcoming race, each driver that has qualified for the race is assigned points corresponding to the inverse of their rank based on the average of their fastest practice times for each practice session recorded. Again, 43 points for the driver who is fastest, and 1 point for the driver with the slowest average times, and the remaining failing somewhere in between to determine a practice time score 234d for each driver.

For the momentum 232e for each driver, each driver that has qualified for the race is put in order according to their momentum number or how well they have been performing over the past predetermined number of races, for example, the last 3 races. A weighting formula is applied to determine each driver's momentum number. First, their finish position over each of the past n races is recorded. For example, for any given race their points would be 43 if they finished first, 42 if they finished second, 41 if they finished third, and continuing to 1 point for finishing last. Each driver will be assigned the proper points for each of the races based on how he finished in the most recent predetermined number of races. Each point is multiplied by a weight factor based on how long ago the race took place. The weight factor is inversely proportional to how long ago the race took place. Therefore, points from older races will be multiplied by a small weight factor and points from more recent races will be multiplied by a larger weight factor. Once the momentum number is calculated, the drivers are ordered according to the momentum number. The position of the momentum number in the rank order is the momentum score 234e.

By way of example only, assume the momentum number is calculated based on the last three races, each race one week apart. The points calculated from the race from 3 weeks ago may be the multiplied by 0.2. The points calculated from the race from 2 weeks ago may be multiplied by 0.3. The points from the most recent race from 1 week ago may be multiplied by 0.5. Therefore, to account for the momentum of the driver, the more recent the past race is to the upcoming race, the higher the weight factor. The points from each of the three races after having been multiplied by their respective weight factor are then summed to determine the momentum number. Therefore, the momentum number may range from 1 to 43 in a race with 43 drivers. The momentum numbers may be rank ordered and the position of the momentum number would be the momentum score.

Using the example above, if a driver finished first each of the past 3 races they would be assigned a momentum number of 43 based on the following calculation: (43×0.2)+(43×0.3)+(43×0.5)=43. This driver would have the highest momentum score of 43. If a driver finished last in each of the past three races that driver would be assigned a momentum number of 1 based on the following calculations: (1×0.2)+(1×0.3)+(1×0.5)=1. This driver would have the lowest momentum score of 1. Drivers finishing in different places for each of the three races will have a momentum number somewhere in between 1 and 43. For example, a driver who finished 5th three weeks ago, 10th two weeks ago, and 20th one week ago would be assigned a momentum number of 30 based on the following calculation: (39×0.2)+(34×0.3)+(24×0.5)=30.

The momentum number may be based upon two or more past races. The sum of the weight factors for each of the past races considered should add up to 1. The weight factor for a given race should be greater than the weight factor for the immediately preceding race to account for the momentum. Therefore, the momentum number is calculated based on Equation 1:

Σ₁ⁿ(Pn*Wn) Equation 1:

where n is the number of past races immediately preceding the upcoming race, where Pₙ is the points earned from the nth race from the upcoming race (i.e. n races ago), Wn is the weight factor for the nth race from the upcoming race, Wₙ is less than Wₙ₋₁, and the sum of all of the weight factors is 1.

Applying this to the example above in which the driver finished 5th three weeks ago, 10th two weeks ago, and 20th one week ago would result in the following: n equals 3 because there are 3 prior races being evaluated. P₁ is the points earned from the most recent race from 1 week ago, P₂ is the points earned from the second most recent race from 2 weeks ago, and P₃ is the points earned from the third most recent race from 3 weeks ago. In this case, the ranking is inversely proportional to the points. So, finishing 20th in the first most recent race results in 24 points, so P₁ equals 24. Finishing 10th in the second most recent race results in 34 points, so P₂ equals 34. Finishing 5th in the third most recent race results in 39 points, so P₃ equals 39. So, the momentum of this driver is going down.

In this example, the weight factor for the most recent race W₁ is 0.5. The weight factor for the second most recent race W₂ is 0.3. The weight factor for the third most recent race W₃ is 0.2. So, the sum of the weight factors W₁ plus W₂ plus W₃ is 1. In addition, any weight factor is greater than any preceding weight factor (e.g. W1 is greater than W2, which is greater than W₃). Therefore, the momentum number for this driver is:

Σ₁³(Pn*Wn)=(P₁*W₁)+(P₂*W₂)+(P₃*W₃)=(24*0.5)+(34*0.3)+(39*0.2)=30.

This can be repeated for all drivers to calculate each momentum number. Note, however, that a driver's momentum number is not always a whole number. For example if a driver finished first at his immediately preceding race, second at the second most recent race, and third at his third most recent race, using the weighting factors above, his momentum number would be (43*0.5)+(42*0.3)+(41*0.2) which equals 42.3. Therefore, once the momentum numbers are assigned to each driver, the drivers may be ordered according to their respective momentum numbers. The driver's momentum score corresponds to the position of the momentum number in the order, which will be an integer from 1 to 43. This becomes the preliminary finishing order as determined by the system.

Therefore, for each of the categories identified, the driver will have a unique score 234a-e, which will be an integer from 1 to 43, where the higher the number, the better the ranking. The scores from each category are summed for a preliminary total score for each driver. The system rank orders the preliminary total score with the highest score receiving the highest ranking to create a preliminary finishing order. These scores are calculated based on characteristics that have been predetermined. Up to this point, the preliminary finishing order will be the same for all of the players. At this point, however, a player can determine how much importance he would like to put on each category. This is a completely subjective determination made by the player. The player will determine the level of importance, referred to as the importance factor 1, for each category. The importance factor 1 the player can choose from ranges from 0 to 1 (in other words 0% to 100%). The sum of the importance factors for each of the categories should total 1 (i.e. 100%).

For example, if the selection tool 230 has five categories, the player can choose an importance factor of 0.05 for the first category, 0.30 for the second category, 0.10 for the third category, 0.26 for the fourth category, and 0.29 for the fifth category. Therefore, the total of the importance factors for each of the categories (0.05+0.30+0.10+0.26+0.29) is 1.

Another player may not care at all about the first four categories and therefore set the importance factor for the first four categories as zero, and the fifth category as 1. Another player may consider each of the factors of equal importance. Therefore, this player will set the importance factor for each of the five categories at 0.2 so that the sum of the importance factor is 1. Quick action buttons 240 may be provided for the most common selection of importance factors.

The final total score takes into account the importance factor the player gives towards each of these categories. The final total score will be reflected in a value (invisible to the player) from 1-43, assigned to each driver in the upcoming race, sorted by descending order with the highest score receiving the number 1 position and the lowest score receiving the number 43 position, and displayed to the player for further refinement (if necessary).

The selection tool 230 provides an importance factor input tool 242 to allow the player to select an importance factor for each category. For example, a sliding scale 244 may be provided as a mechanism for choosing a number from 0-1. The player can slide the slider 246 along the sliding scale 244 that corresponds to the number for the importance factor. In another embodiment, a text field 248 may be provided for the player to manually type in the number associated with the importance factor for each category. In another embodiment, a greater than or less than symbol 250 or plus and minus symbol may be provided for the player to click on to incrementally raise or lower the importance factor. Any combination of these and any other way to allow the player to select the importance factor for each category can be utilized.

Once the player selects the importance factor 1 for each category 232a-e so it reflects the importance he wants applied to a particular category, a submit button 252 will allow the system to take into consideration the importance factor 1 and provide the predicted finishing order for that player, which essentially reorders the list. The importance factors 1 set by the player for each category will be multiplied by the score for that respective category. These numbers may be summed to determine a final total score. This can be done for each driver. The final total scores for each driver may be sorted in numerical order, which will determine the predicted finishing order of what the player believes will be in the upcoming race. This order will be displayed for the player to see. The player can save this order, or manually change the order. A recall button 254 may be provided to recall a previous saved list.

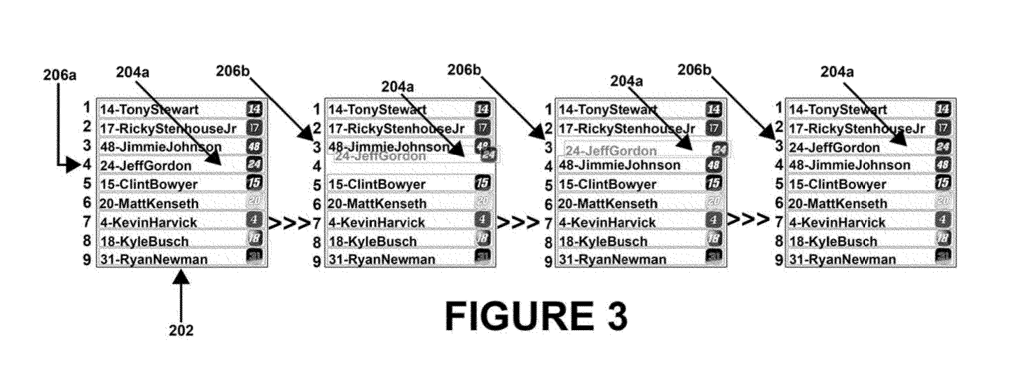

As shown in FIG. 3, to manually change the order, the player can select a driver 204a located at one position 206a on the list 202 and drag the driver 204a to a different position 206b on the list. For example, on a touchscreen device, the player can touch the name of the driver and move it to a different position on the list. Using a mouse, the player can click on the name of the driver, and while holding the mouse button down, move the name of the driver to a different position and release the button. In another embodiment, the player may click on the position number adjacent to the driver's name and change it to the position he wants that driver to be in. For example, if the player thinks that the driver in the third-place position will actually finish second, then the player can change the number 3 of the third-place position driver to the number 2 and update the list. The order of all of the other drivers will update automatically.

Once the player is satisfied with the rank order of the drivers, a save button 220 is provided to save this predicted finishing order and take the player to the main race viewing page. The player can change his predicted finishing order at any time until the race begins.

If the player does not input any importance factors, then the preliminary total score may be used as the final total score to be rank ordered to establish the predicted finishing order. In other words, by default, the preliminary finishing order becomes the predicted finishing order if the player does not input the importance factors. Therefore, either the preliminary finishing order or the predicted finishing order becomes the final finishing order used for the game.

In some embodiments, the importance factors established by the player the previous race may be stored in the player's account. If the player does not log in to change the importance factors, then the importance factors from the previous race will automatically be applied to the upcoming race. This has the unique feature of allowing the player to be competitive in any upcoming race regardless of whether he logs in to make his prediction for the upcoming race because the player does not have to select the drivers, but rather, only alters the order of the drivers selected by the system based on the upcoming race.

By contrast, in other fantasy leagues, if a player does not log in to take action on his list of drivers, the system may automatically use the same drivers list for the game. This can create a problem if a driver was in the previous race, but for some reason, has dropped out of the upcoming race. So, if the same driver list from the week before was submitted, some drivers would not match the upcoming race, which will adversely affect the player's score. Similarly, other fantasy games (football, baseball, racing, etc.) will cause the player's points to suffer greatly if the player does not sign in each week to “bench” a competitor or driver if for some reason the competitor or driver is not competing in the upcoming event.

This is avoided in the present invention because the drivers list would always be correct because it is updated by the system based on the actual drivers of the upcoming race. By employing the previous importance factors, the player remains competitive.

Watching the Race

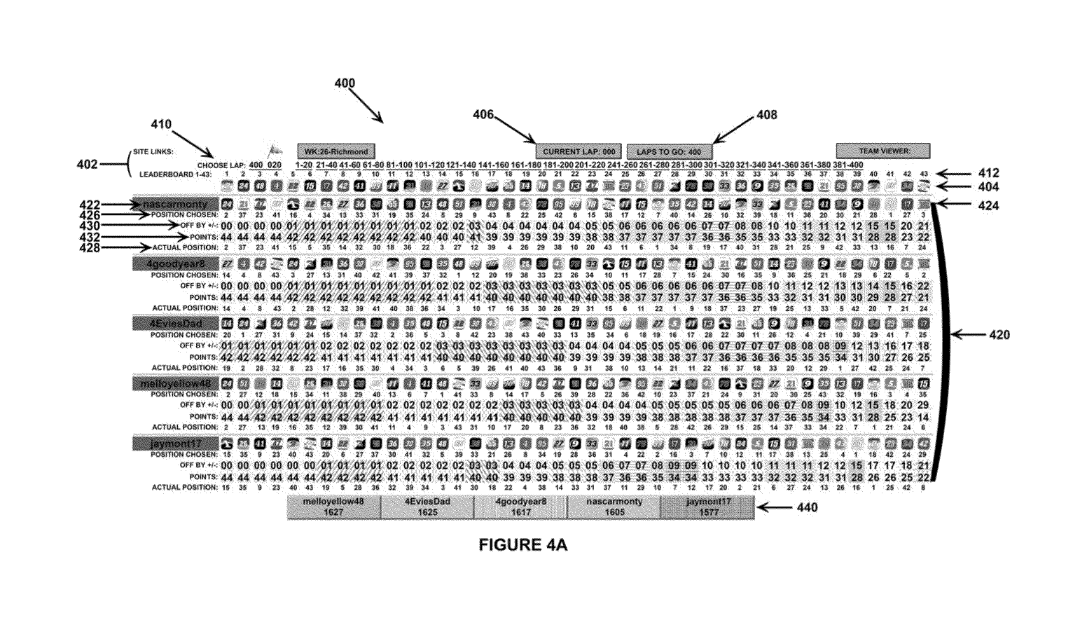

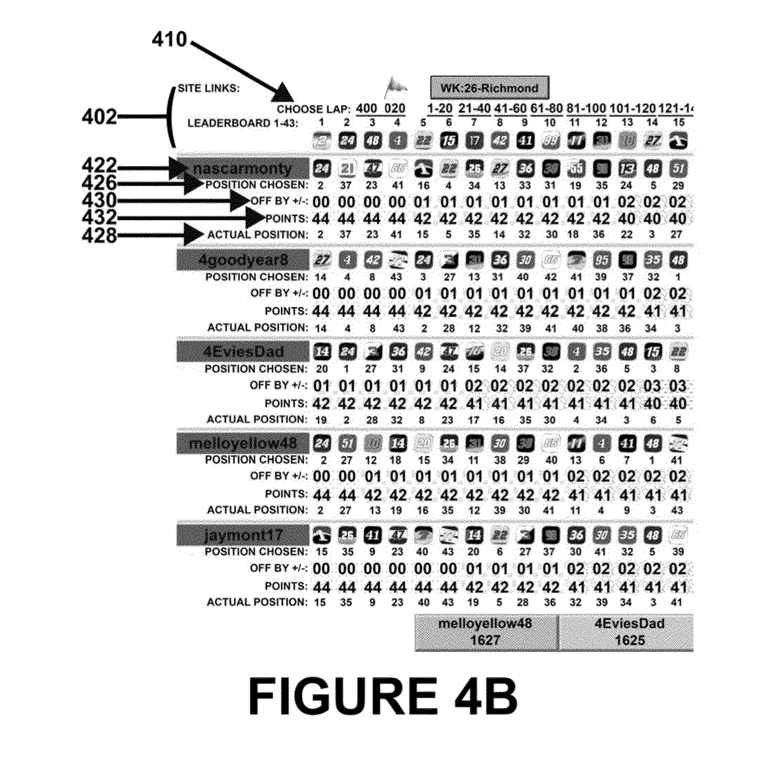

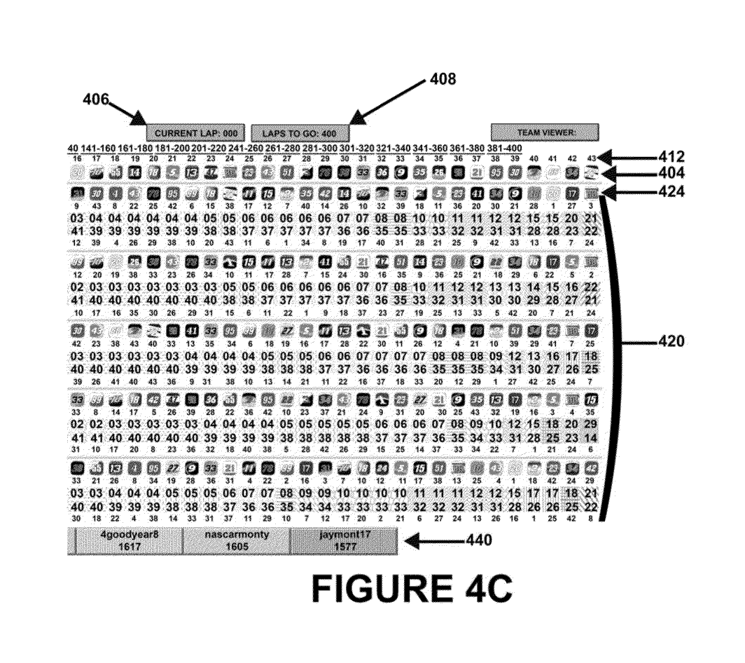

Links may be provided that allows a player to select a team he may be on and display a viewing page 400 which displays how points are being awarded towards each team player's predicted finishing order. Players are able to view their team or up to any of the other teams they may be on. With reference to FIGS. 4A-C, in one section of the viewing page 400 (for example, across the top of the viewing page), race information 402 may be displayed. For example, the race information 402 may comprise the current, real-time order of the drivers 404 (represented as a driver's icon in form of the driver's name, car number, moniker, etc.), the current lap 406, the number of laps to go 408, and a lap selection tool 410 to allow the player to select a lap of interest. Selecting a particular lap will display the rank order 412 of the drivers during that lap. Additional race information can be provided, such as any accidents or hazards, any newsworthy activity, and the like.

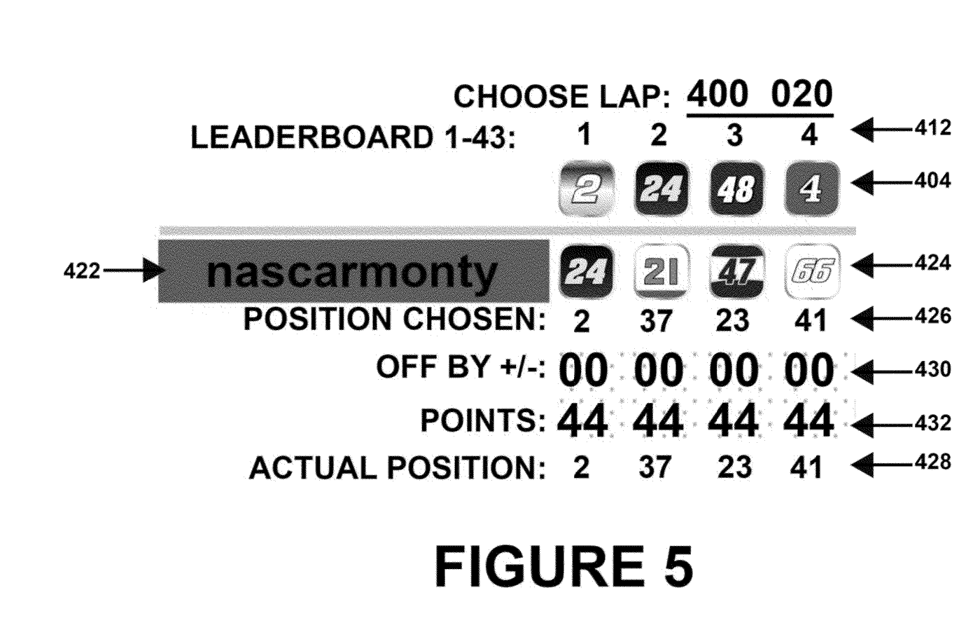

In another section of the viewing page 400 (for example, below the race information), the players selection information 420 may be displayed. The players selection information 420 may comprise a list of each player's identifying information 422 who is on the team, such as name or username. If the player is not a part of a team, then his information will be the only one displayed. As shown in FIG. 5, for each player listed, a custom listing of the drivers 424 will be displayed in the form of the driver's name, car number, moniker, or any combination thereof, referred to as the driver's icon. Adjacent to the listing of the drivers may be the predicted position 426 made by the player for that driver, the actual position of the driver 428 for the lap selected, the difference between the predicted position and the actual position 430, and the player's points 432 associated with that driver based on the difference between the predicted position and the actual position. The player's points 432 for each driver may be based on the number of drivers minus the absolute value of the difference between the position chosen and the actual position. For example, in a race with 43 drivers, if the position chosen by player 1 for driver number 24 is position 2 and the actual position of driver number 24 is position 2, then the difference is zero. Therefore, the number of points for player 1 for driver 24 is 43 (43 minus 0). In some embodiments, the player may receive a bonus, for example, an extra point, for an accurate prediction. So in the example above, player 1 would have received 44 points for driver number 24. If the position chosen by player 1 for driver number 1 is 16 and the actual position is 15, then the absolute value of the difference between the position chosen and the actual position is 1. Therefore, the number of points for player 1 for driver number 1 is 42 (43 minus 1). If the position chosen by player 1 for driver number 88 is 3 and the actual position is 24, then the absolute value of the difference between the position chosen and the actual position is 21 (24 minus 3). Therefore, the number of points for player 1 for driver number 88 is 22 (43 minus 21). These points can be calculated for each driver for a given player. The custom listing of the drivers may be based on the player's points. For example, the custom listing of the drivers for a given player may be in the order of the highest points to the lowest points. The sum of the points for all of the drivers for the player is the player's total score. This calculation can be done for each player on the team and the total scores displayed on the viewing page for each member to see who is in the lead.

Links may be provided on the viewing page that will load a particular lap that a player wishes to see. This is especially useful if watching a race that was recorded earlier. It allows the player to only reveal race information (points or scores) as it times out with the playback of their recording.

All data is displayed in a way that allows the player to see the position of each car (for the selected lap), how many points they are receiving for that car, how many points each of their teammates is receiving for each car, what the player's total score is for each player on their team, and each player's rank 440 based on their total score (first place through fifth place, for example).

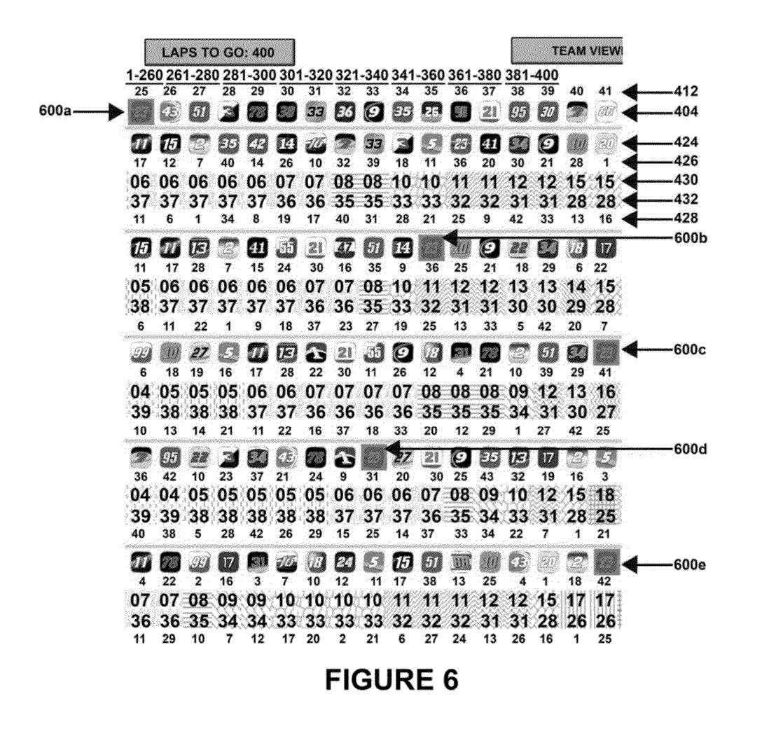

As shown in FIG. 6, in some embodiments, actuating a specific driver's icon, for example, hovering the mouse over a driver's icon or selecting a driver's icon, will cause it and all other occurrences of that specific driver's icons on the page to be highlighted 600a-e. For example, actuating car number 23 on player 1's listing would cause all occurrences of car number 23 on the page (i.e. car number 23 on player 2's custom listing, player 3's custom listing, etc.), to be highlighted in some way, such as blinking, changing to the same color, or otherwise changing in a noticeable and coordinated manner. This is useful when trying to see the same driver on another user's display line.

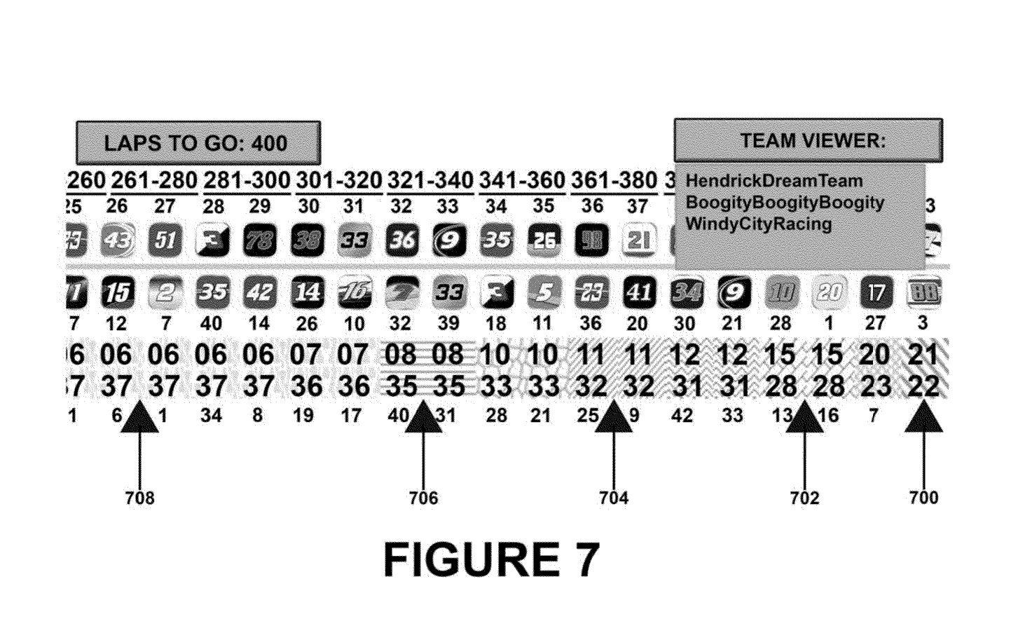

In some embodiments, color coding may be used as an indicator of how far off the player was with his predictions compared to the actual position of a driver. For example, colors ranging from deep red 700 though orange 702, yellow 704, lime 706, green 708, and various shades of each color in between may be used as an indicator of whether a player was off by a lot or whether the player predicted accurately. As shown in the example in FIG. 7, for player 1 (nascarmonty), his prediction regarding the ranking of driver number 88 was off by 21 positions, so the display of this number and his points for this driver is shown highlighted as deep red. For driver number 20, player 1 was off by 15 positions, so the display of the points associated with this driver is highlighted in yellow. Player 1's prediction of driver 41 was off by 11 positions, so the information for this driver is displayed highlighted in lime, and so on. When arranged by point order, a color spectrum ranging from dark green to dark red can be seen (as shown in FIG. 4A) so that the player can quickly see whether his predictions were mostly accurate, way off, or somewhere in between. For example, if the color spectrum is predominantly green, the player knows his predictions were fairly accurate. But, if there is a lot of red showing, the player knows his predictions were inaccurate and may have to reconsider his prediction methodology. Any other color spectrum can be used.

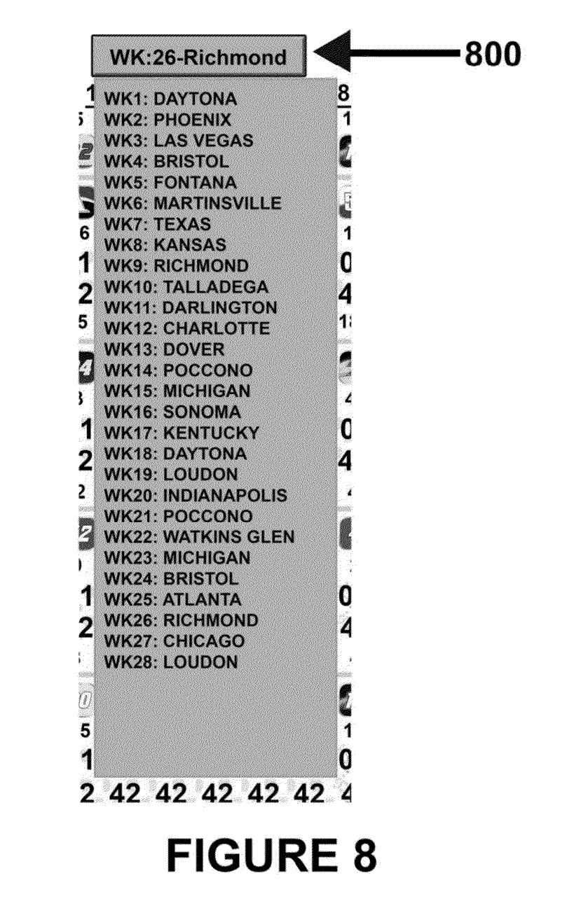

As shown in FIG. 8, links 800 may be provided that will load race data from previous races in the current season. Hyperlinks or drop-down menus and the like can be used for the player to select a previous race. Selecting the previous race take the player to a viewing page to see the same race data, but for the race selected.

In some embodiments, a graph plots out where each of the 5 possible players were in relation to each other throughout the race. In some embodiments, the listing of the players on the viewing page may be in the order of the player with the highest points. This display of the listing can change as the players score changes. In some embodiments, the players may be listed elsewhere on the page in order of the person with the highest total score, with the summary of the score displayed so as not to be confusing.

In some embodiments, teams can play against each other for the highest points. The points considered for each team may be the cumulative total of each team member, or it may be the average point of all members on the team. In some embodiments, the team administrator may be able to apply a player factor for each player. This is similar to the importance factor 1 applied to the categories by each team member for their own drivers list. The administrator can weight the importance of each of his team members' predictions by applying the player factor to the final total score of each of his team members. Therefore, if a particular member tends to predicted accurately, the administrator can assign that member a high player factor. Conversely, if a particular member tends to predict inaccurately, the administrator can assign a low player factor. Like the importance factor, the sum of each team members' player factor should total 1 (100%).

In some embodiments, any user or any team may play against the system. For example, the system may establish a certain number of points the player or team must achieve in order to win. In a gambling setting, the system may establish odds for achieving a certain number of points. A player or a team may place a wager on the number of points they think they can achieve. If they achieve their goal, they may be paid out according to the odds. Based on the set, the system can establish odds for many different types of outcomes. For example, the system can establish odds that a user can determine the correct finishing order, the winner of the race, the finishing position of a particular driver, finishing time of any driver, whether any accidents will occur, and the like. Prizes may be awarded in the form of money, goods, and/or services.

Even in embodiments in which members play against each other or teams play against each other, prizes in the form of money, goods, and/or services, can be won for various correct predictions, such as the correct finishing order, the winner of the race, the finishing position of a particular driver, finishing time of any driver, whether any accidents will occur, and the like.

In various embodiments, the method steps described herein may be performed in an order different from the particular order described or shown. In other embodiments, other steps may be provided, or steps may be eliminated, from the described methods.

Systems, apparatus, and methods described herein may be implemented using digital circuitry, or using one or more computers using well known computer processors, memory units, storage devices, computer software, and other components. Typically, a computer includes a processor for executing instructions and one or more memories for storing instructions and data. A computer may also include, or be coupled to, one or more storage devices, such as one or more magnetic disks, internal hard disks and removable disks, optical disks, etc.

Systems, apparatus, and methods described herein may be used within a network-based cloud computing system 900. In such a network-based cloud computing system 900, one or more servers 940A, 940B or another processor, and associated database 950, that is connected to a network communicates with one or more client computers 920A, 920B, 920C via a network 910. For example, a client computer may communicate with the server via a network browser application residing and operating on the client computer. A client computer 920A, 920B, 920C may store data on the server 940A, 940B and access the data via the network 910. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

For example, a server may transmit a request adapted to cause a client computer to perform one or more of the methods described herein. Certain steps of the methods described herein may be performed by a server or by another processor in a network-based cloud-computing system. Certain steps of the methods described herein may be performed by a client computer in a network-based cloud computing system. The steps of the methods described herein may be performed by a server and/or by a client computer in a network-based cloud computing system, in any combination.

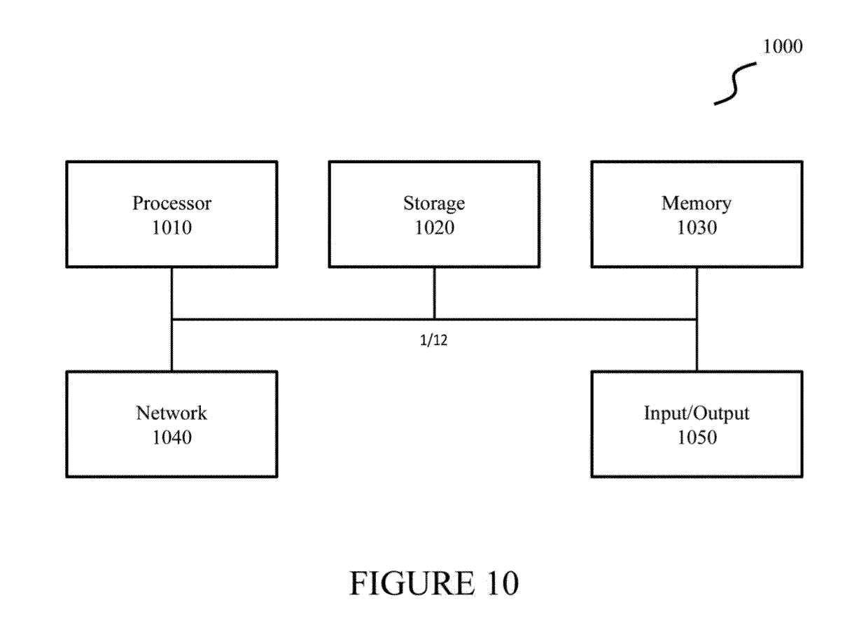

A high-level block diagram of an exemplary computer 1000 that may be used to implement systems, apparatus, and methods described herein is illustrated in FIG. 10. The computer 1000 comprises a processor 1010 operatively coupled to a data storage device 1020 and memory 1030. Processor 1010 controls the overall operation of computer 1000 by executing computer program instructions that define such operations. The computer program instructions may be stored in data storage device 1020, or other non-transitory computer readable medium, and loaded into memory 1030 when execution of the computer program instructions is desired. Thus, the method steps can be defined by the computer program instructions stored in memory 1030 and/or data storage device 1020 and controlled by processor 1010 executing the computer program instructions.

For example, the computer program instructions can be implemented as computer executable code programmed by one skilled in the art to perform the algorithms defined herein. Computer 1000 also includes one or more network interfaces 1040 for communicating with other devices via a network. Computer 1000 also includes one or more input/output devices 1050 that enable user interaction with computer 1000 (e.g., display, keyboard, touchpad, mouse, speakers, buttons, etc.).

Processor 1010 can include, among others, special purpose processors with software instructions incorporated in the processor design and general purpose processors with instructions in storage device 1020 or memory 1030, to control the processor 1010, and may be the sole processor or one of multiple processors of computer 1000. Processor 1010 may be a self-contained computing system, containing multiple cores or processors, a bus, memory controller, cache, etc. A multi-core processor may be symmetric or asymmetric. Processor 1010, data storage device 1020, and/or memory 1030 may include, be supplemented by, or incorporated in, one or more application-specific integrated circuits (ASICs) and/or one or more field programmable gate arrays (FPGAs). It can be appreciated that the disclosure may operate on a computer 1000 with one or more processors 1010 or on a group or cluster of computers networked together to provide greater processing capability.

Data storage device 1020 and memory 1030 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Network/communication interface 1040 enables the computer 1000 to communicate with networks, such as the Internet, also referred to as the World Wide Web (WWW), an intranet and/or a wireless network, such as a cellular telephone network, a wireless local area network (LAN) and for a metropolitan area network (MAN), and other devices using any suitable communications standards, protocols, and technologies. By way of example, and not limitation, such suitable communications standards, protocols, and technologies can include Ethernet, Token Ring, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 1040 enables the computer 1000 to transfer data, synchronize information, update software, or any other suitable operation.

Input/output devices 1050 may include peripherals, such as a printer, scanner, monitor, etc. Input/output devices 1050 may also include parts of a computing device, such as a smartphone having a touchscreen, speakers, and buttons. For example, input/output devices 1050 may include a display device such as a liquid crystal display (LCD) monitor for displaying information to the user, a keyboard and mouse by which the user can provide input to the computer 1000, or a touchscreen for both input and output.

Any or all of the systems and apparatus discussed herein, including personal computers, tablet computers, hand-held devices, cellular telephones, servers, database, cloud-computing environments, and components thereof, may be implemented using a computer such as computer 1000.

One skilled in the art will recognize that an implementation of an actual computer or computer system may have other structures and may contain other components as well, and that FIG. 10 is a high level representation of some of the components of such a computer for illustrative purposes.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of playing a fantasy online racing game, comprising:
a. displaying a preliminary finishing order on a selection page for an upcoming race having a track, wherein the preliminary finishing order comprises a driver identification and a driver's position for each driver listed, wherein the driver's position of any driver can be moved, wherein moving the driver's position of any driver automatically updates the position of all other drivers;
b. providing a selection tool for a player to determine a predicted finishing order for the upcoming race, the selection tool displaying:
i. categories that can be used in determining the predicted finishing order, wherein the categories comprise scores selected from the group consisting of a current ranking score, a track history score, a qualifying time score, a practice time score, and a momentum score, wherein the current ranking score is based on a current ranking of the driver, wherein the track history score is based on the driver's past performance on the track, wherein the qualifying time score is based on the driver's qualifying time, wherein the practice times score is based on an average of the driver's fastest practice times for each practice session recorded for the track, and the momentum score is based a predetermined number of previous races (n), wherein a momentum number is determined by a weighting formula as follows: Σ₁ⁿ(Pn*Wn), wherein n designates a number of immediate prior races from the upcoming race, where Pₙ is points earned from the nth prior race from the upcoming race, Wₙ is a weight factor for the nth prior race, wherein Wₙ<Wₙ₋₁, and a sum of all of the weight factors is 1, and
ii. importance factor input tools, wherein the player can apply an importance factor to each category with the importance factor input tools, wherein a sum of the importance factors is 1;
c. displaying the predicted finishing order according to the results of the selection tool;
d. allowing the player to manually adjust the predicted finishing order to establish a final finishing order;
e. receiving the final finishing order of the player; and
f. displaying a viewing page, the viewing page comprising:
i. a race information displaying a current, real-time order of the drivers' icons, a current lap, and a number of laps to go; and
ii. a players selection information, comprising a list of each player's identifying information, and for each player, displaying a custom listing of the drivers icons, a predicted position chosen by the player for each driver, an actual position of the driver for a selected lap, a difference between the actual position and the predicted position, and a player's points, wherein the player's points is based on a number of drivers minus the absolute value of the difference between the predicted position and the actual position, wherein the custom listing of the drivers icon is based on the player's points, and wherein the player's points is displayed with color coding as an indicator of a proximity of the predicted position to the actual position to determine how far off the player was with the player's predictions compared to the actual position of a driver.

2. The method of claim 1, wherein actuating a specific driver's icon highlights all occurrences of that specific driver's icon on the viewing page.

3. A method of playing a fantasy online racing game, comprising:
a. displaying a preliminary finishing order on a selection page for an upcoming race having a track;
b. providing a selection tool for a player to determine a predicted finishing order for the upcoming race;
c. displaying the predicted finishing order according to the results of the selection tool;
d. receiving a final finishing order of the player; and
e. displaying a viewing page, the viewing page comprising:
i. a race information; and
ii. a players selection information, comprising a list of each player's identifying information, and for each player, displaying a custom listing of the drivers icons.

4. The method of claim 3, wherein the preliminary finishing order comprises a driver identification and a driver's position for each driver listed, wherein the driver's position of any driver can be moved, wherein moving the driver's position of any driver automatically updates the position of all other drivers

5. The method of claim 3, wherein the selection tool comprises categories that can be used in determining the predicted finishing order.

6. The method of claim 5, wherein the categories comprise scores selected from the group consisting of a current ranking score, a track history score, a qualifying time score, a practice time score, and a momentum score.

7. The method of claim 6, wherein the current ranking score is based on a current ranking of the driver.

8. The method of claim 6, wherein the track history score is based on the driver's past performance on the track.

9. The method of claim 6, wherein the qualifying time score is based on the driver's qualifying time.

10. The method of claim 6, wherein the practice times score is based on an average of the driver's fastest practice times for each practice session recorded for the track.

11. The method of claim 6, wherein the momentum score is based a predetermined number of previous races (n), wherein a momentum number is determined by a weighting formula as follows: Σ₁ⁿ(Pₙ*Wₙ), wherein n designates a number of immediate prior races from the upcoming race, where Pₙ is points earned from the nth prior race from the upcoming race, Wₙ is a weight factor for the nth prior race, wherein Wₙ<Wₙ₋₁, and a sum of all of the weight factors is 1.

12. The method of claim 5, further comprising importance factor input tools, wherein the player can apply an importance factor to each category with the importance factor input tools, wherein a sum of the importance factors is 1.

13. The method of claim 12, wherein if the player does not use the importance factor input tools, then the importance factor from a previous race is used.

14. The method of claim 3, wherein the race information comprising a current, real-time order of the drivers' icons and wherein actuating a specific driver's icon highlights all occurrences of that specific driver's icon on the viewing page.

15. The method of claim 3, wherein the players selection information further comprises:
a. a predicted position chosen by the player for each driver;
b. an actual position of the driver for a selected lap;
c. a difference between the actual position and the predicted position; and
d. a player's points, wherein the player's points is based on a number of drivers minus the absolute value of the difference between the predicted position and the actual position, wherein the custom listing of the drivers icon is based on the player's points.

16. The method of claim 15, wherein the player's points is displayed with color coding as an indicator of a proximity of the predicted position to the actual position to determine how tar off the player was with the player's predictions compared to the actual position of a driver.

17. A system for playing online fantasy racing games, the system comprising: a server connected to a network, the server comprising: at least one processor; a database for storing information; and a memory operatively coupled to the processor, the memory storing program instructions that when executed by the processor, causes the processor to:
a. display a preliminary finishing order on a selection page for an upcoming race having a track;
b. provide a selection tool for a player to determine a predicted finishing order for the upcoming race;
c. display the predicted finishing order according to the results of the selection tool;
d. receive a final finishing order of the player; and
e. display a viewing page, the viewing page comprising:
i. a race information; and
ii. a players selection information, comprising a list of each player's identifying information, and for each player, displaying a custom listing of the drivers icons.

18. The system of claim 17, wherein the preliminary finishing order is determined by calculating a preliminary total score based on any one or more categories selected from the group consisting of current ranking, track history, qualifying time, practice time, and momentum.

19. The system of claim 18, further comprising a selection tool to input an importance factor for each category.

20. The system of claim 17, wherein the players selection information comprises player's points arranged in ranked order and displayed with a color spectrum reflecting a proximity of a predicted position of a driver from the driver's actual position in the race.
